(19) United States
(12) Patent Application Publication
(10) Pub. No.: US 2006/0085913 A1
(43) Pub. Date: Apr. 27, 2006

(54) Movable bed

(76) Inventors: Hideo Kawakami, Hirakata-shi,Osaka (JP); Kenji Taguchi, Hirakata-shi, Osaka (JP)

Correspondence Address: MCDERMOTT WILL & EMERY LLP, 600 13TH STREET, N.W., WASHINGTON, DC, 20005-3096, US

(21) Appl. No.: 10/526,044

(22) PCT Filed: Aug. 26, 2003
(86) PCT No.: PCT/JP03/10730

§ 371 Date: Sep. 1, 2005

(30) Foreign Application Priority Data
Aug. 29, 2002 (JP) 2002-251233

(51) Int. Cl. A61G 7/015; A61G 7/008

(52) U.S. Cl. 5/618; 5/607; 5/624

(57) ABSTRACT

An adjustable bed includes a moving mechanism operable to at least tilt or move up and down a platform of the bed, and a safety switch operable to turn ON and OFF in response to movement of the platform. The moving mechanism is suspended when a power ON-OFF state of the safety switch is changed due to displacement of the safety switch from a predetermined position. In addition, a cover may be disposed over the moving mechanism from an outer surface. The safety switch is disposed at a position determined relative to a position of the cover. The power ON-OFF state of the safety switch is changed upon displacement of the cover from the position.

### TECHNICAL FIELD

The present invention relates to an adjustable bed for use in nursing care and the like, and particularly to a safety mechanism of the adjustable bed.

### BACKGROUND ART

Generally, adjustable beds used as postural change assistance beds assist postural changes of a care recipient in order to prevent the occurrence of decubitus ulcers, more commonly known as bedsore. To this end, such an adjustable bed tilts at least part of the mattress on which the person is lying at an angle (see Japanese Published Patent Publication No. 6-14824). The majority of these types of beds employ a mechanism that tilts the mattress toward one side from a horizontal position.

A driving mechanism (moving mechanism) for the above adjustable bed is normally provided below a platform of the bed and in an exposed condition. Consequently, there is a danger that a hand of caregivers, care recipients, or their family members gets caught in the moving mechanism. For the sake of safety in operation, the movable bed needs to be improved.

### DISCLOSURE OF THE INVENTION

The present invention is made in view of the above problems, and aims to provide an adjustable bed having a safety mechanism allowing a care giver, a care recipient, and a family member to safely operate the bed.

To address the above problems, the present invention provides an adjustable bed including: a moving mechanism operable to at least tilt or move up and down a platform of the bed; and a safety switch operable to turn ON and OFF in response to movement of the platform. The moving mechanism is suspended when a power ON-OFF state of the safety switch is changed due to displacement of the safety switch from a predetermined position.

Specifically, the adjustable bed may further include a changeover member operable, in response to movement of the platform, to change the power ON-OFF state of the safety switch.

With the adjustable bed having the above structure, first of all, the moving mechanism is made to stop operating upon displacement of the safety switch from the predetermined position. Thus, in the case where a foreign object or a part of human body gets caught in the moving mechanism, the moving mechanism stops operating, before being excessively stressed and damaged. As described above, the present invention effectively restricts unnecessary accesses to the moving mechanism. In addition, the present invention provides significantly improved security by immediately suspending the operation of the adjustable bed when a foreign object or a part of human body gets caught in the moving mechanism.

Second of all, the immediate suspension of the bed operation achieves the effect of preventing an excessive stress to the moving mechanism.

Specifically, the adjustable bed may further include a cover disposed so as to cover an outer surface of the moving mechanism. The safety switch is disposed at a position determined relative to a position of the cover. The power ON-OFF state of the safety switch is changed upon displacement of the cover from the position.

Further, the moving mechanism may include: a flexing mechanism operable to flex the platform to form a flexion position that includes at least one of an upper body elevation and a knee flexion; and a tilting mechanism operable to laterally tilt the platform. The flexing and tilting mechanisms are each operable when the other mechanism is operating. The cover is mounted to the tilting mechanism.

Still further, the adjustable bed may further include: a side member disposed on a side of the platform, and a side member raising mechanism for raising the side member relative to the platform. The tilting mechanism downwardly tilts the platform toward the side member raised by the side member raising mechanism.

### BRIEF DESCRIPTION OF THE DRAWINGS

FIG. 1 is an oblique view of an adjustable bed according to an embodiment 1 of the present invention;

FIGS. 2A-2C are sectional views of the bed showing an adjustable stage and its nearby portion;

FIG. 3 is a schematic top view of the bed;

FIG. 4 is an oblique view of a fixed stage;

FIG. 5 is an oblique view of the bed (with left side members risen);

FIG. 6 is an oblique view of the bed (in a flexion position);

FIG. 7 is an oblique view of the bed (downwardly tilted toward the left);

FIG. 8A is a schematic side view of a bed frame (in a horizontal position), FIG. 8B is a schematic side view of the bed frame (in a flexion position), FIG. 8C is a schematic side view of the bed (in a horizontal position), and FIG. 8D is a schematic side view of the bed (in a flexion position), all seen lengthwise;

FIG. 9 is an oblique view of the fixed stage provided with mechanics covers;

FIG. 10A is a block diagram of a control unit, and FIG. 10B is a view showing the structure around the mechanics cover; and

FIG. 11A is an oblique view showing an adjustable bed (modification), and FIG. 11B is an oblique view sowing operation of the modified adjustable bed.

### BEST MODE FOR CARRYING OUT THE INVENTION

### 1. Embodiment 1

Hereinafter, a description is first given to the overall structure of an adjustable bed according to an embodiment 1 of the present invention. Then, a detailed description is given to the safety mechanism (utilizing a mechanics cover) of the bed.

1-1. Structure of Postural Change Assistance Bed

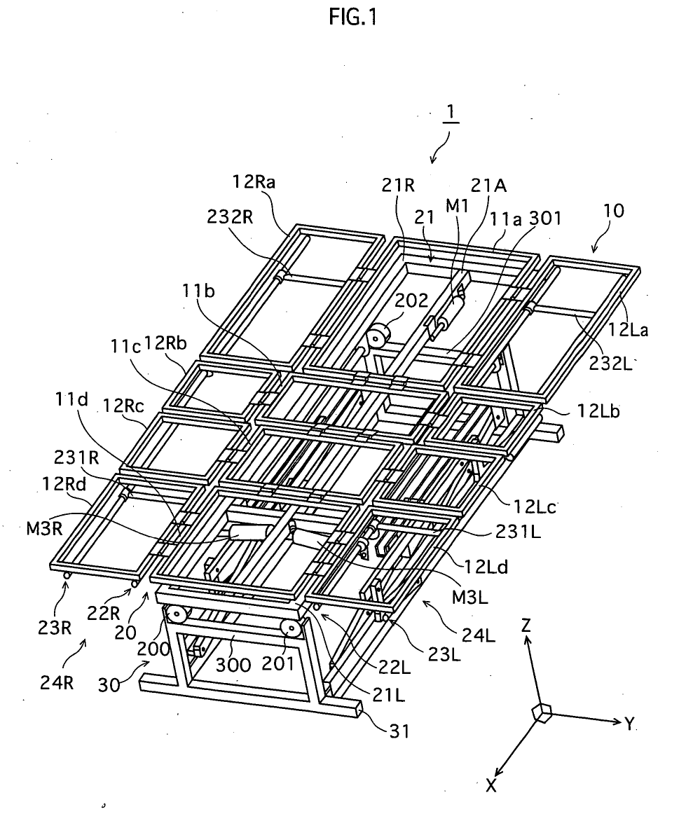

FIG. 1 is an oblique view showing the overall structure of an adjustable bed 1 according to the embodiment 1 of the present invention.

The bed 1 shown in the figure is constituted such that a bed frame 10 is placed on an adjustable stage 20 which in turn is placed on a fixed stage 30.

The bed frame 10 has a surface area that is composed of four platform members 11a-11d for suitably receiving four articulations (the upper body, lower body, upper leg, and lower leg regions) of the care recipient's body when lying on the bed. The four platform members 11a-11d are movably coupled to constitute a coupled platform. More specifically, the bed frame 10 is composed of an upper-body member 11a, a lower-back member 11b, an upper-leg member 11c, and a lower-leg member 11d coupled in the stated order.

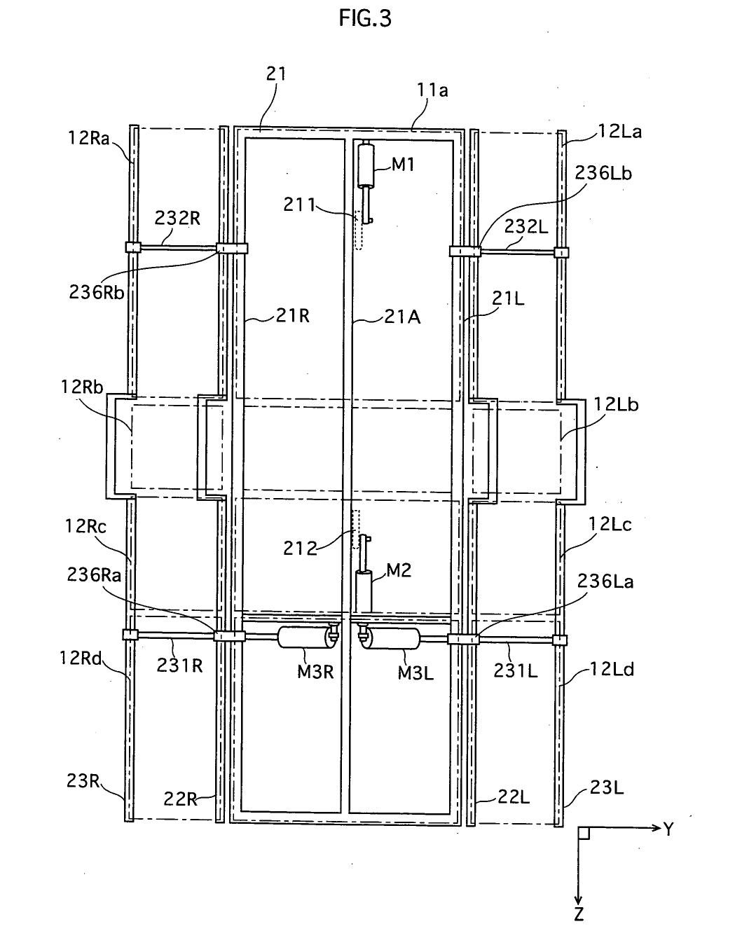

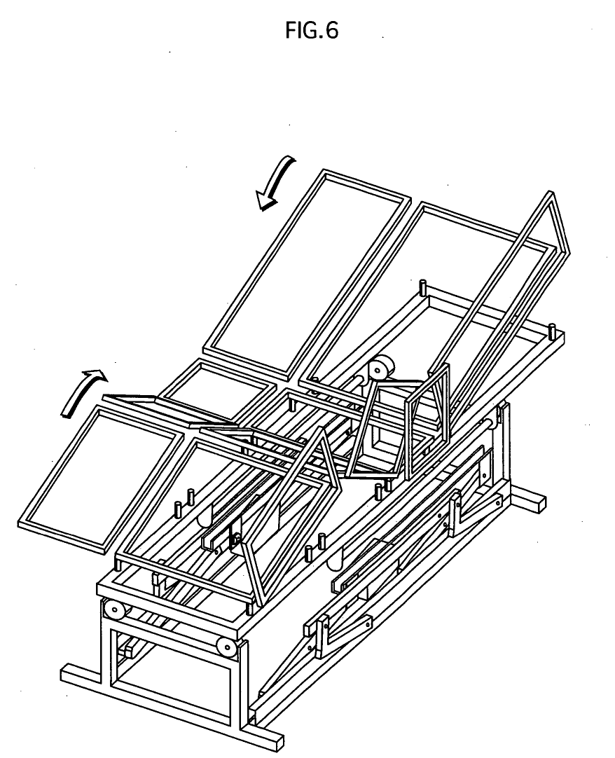

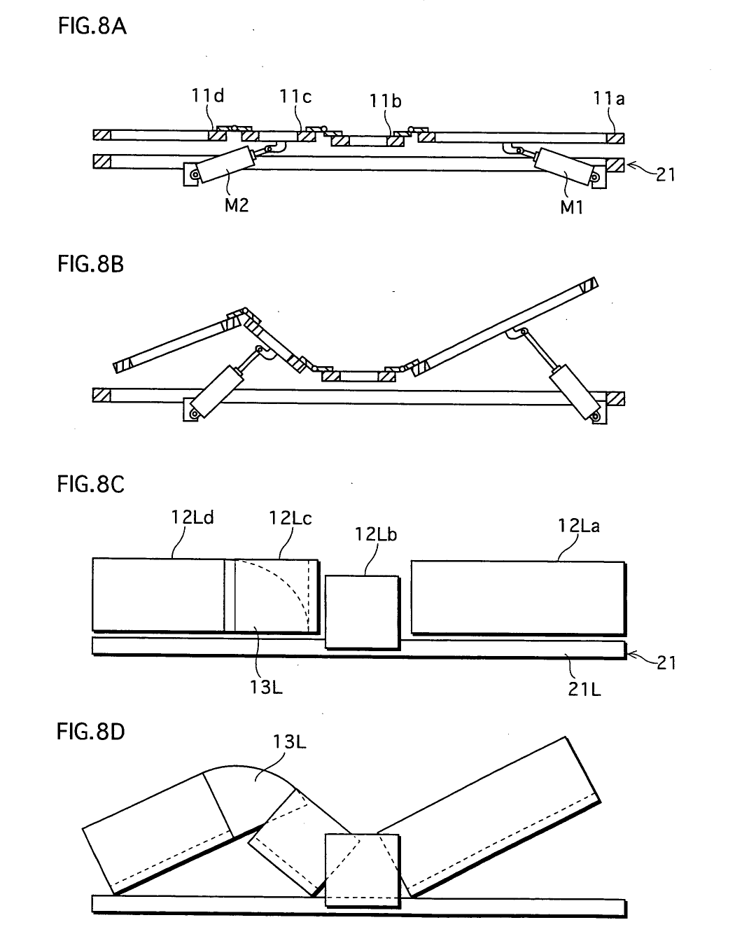

The lower-back member 11b is directly secured to the adjustable stage 20 by welding, for example. Thus, the bed frame 10 is not detachable from the adjustable stage 20. The platform members 11a-11d are each flanked by respective pairs of side members 12Ra-12Rd and 12La-12Ld coupled thereto from the right and left. The side members 12Ra-12Rd and 12La-12Ld support the care recipient's body from the side at the time of postural change. The upper-body member 11a of the bed frame 10 is coupled to the shaft of a direct-acting actuator M1 via an L-shaped coupler 211, whereas the upper-leg member 11c is coupled to the shaft of a direct-acting actuator M2 via an L-shaped coupler 212. The actuators M1 and M2 are disposed on a center beam 21A of the adjustable stage 20. (See FIG. 3 showing a top view of the bed.) Thus, by the action of the actuators M1 and M2, the bed's profile is adjusted to bring the care recipient into a flexion posture (see FIG. 6 showing a state of the bed and FIG. 8B showing a side view of the bed).

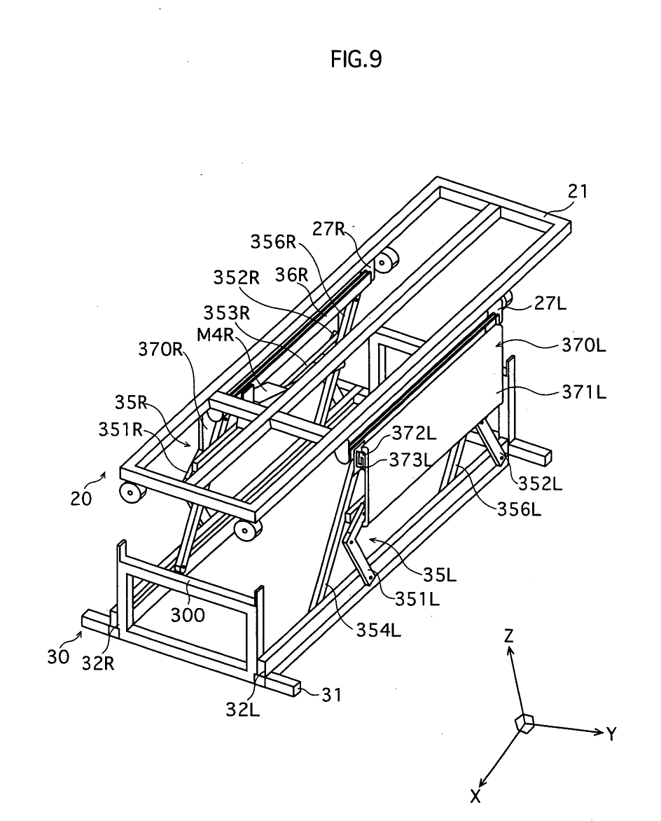

Note that each of the platform members 11a-11d as well as the side members 12Ra-12Rd and 12La-12Ld are covered by wire mesh. In the drawings, however, the wire mesh is omitted to show the frames of the platform members 11a-11d and of the side members 12Ra-12Rd and 12La-12Ld in order to clearly illustrate the structure and operation of the bed. In addition, although the fixed stage 30 is provided with mechanics covers 370R and 370L serving as a safety mechanism, the mechanics covers 370R and 370L are shown in FIGS. 9 and onward. In FIGS. 6-8 showing bed operations, in addition, some of the constituent elements, such as side-member support frames 24R and 24L, are omitted so as to clearly illustrate the bed operations.

As mentioned above, among the side members 12Ra-12Rd and 12La-12Ld, the side members 12Rc and 12Lc are located at positions corresponding to the upper-legs of the care recipient. The side members 12Rc and 12Lc are each provided, on the surface, with an envelope-like pocket that is approximately the same size as the side members 12Rc and 12Lc (see FIG. 8D showing a side view of the bed). In addition, the side members 12Rd and 12Ld located at positions corresponding to the lower-legs of the care recipient are coupled, along the edge, to fan-shaped members 13R and 13L, respectively (13R is not illustrated). Normally, the fan-shaped members 13R and 13L are housed in the above-mentioned pockets of the side members 12Rc and 12Lc. When the bed frame 10 is adjusted to a position for the flexion posture, the fan-shaped members 13R and 13L come out of the pockets to support the care recipient's knees.

The adjustable stage 20 has a rectangular frame construction formed from the center beam 21A, side beams 21R and 21L, and two parallel frames each connecting the respective ends of the center and side beams. As illustrated in the figures, the side beams 21R and 21L are provided with rollers 200, 201, 202, and 203 allowing sliding movement of the side beams 21R and 21L along a roller slide frame 300 in the direction of y (the roller 203 is hidden beneath the bed frame 10).

The side beam 21R of the adjustable stage 20 is provided with a pair of bars 22R and 23R extending along the side beam 21R, as well as with connecting bars 231R and 232R. The pair of bars 22R and 23R and the connecting bars 231R and 232R together constitute a ladder-like side-member support frame 24R. Similarly, the side beam 21L is provided with a ladder-like side-member support frame 24L constituted of a pair of bars 22L and 23L extending along the side frame 21L, as well as of connecting bars 231L and 232L. The bars 22R, 23R, 22L, and 23L each have bends defining a concave along its lengthwise direction. The concaves are formed at positions where the side members 12Rb and 12Lb engage against the side-member support frames 24R and 24L, respectively. Consequently, the side member 12Rb fits within the concave (see FIG. 3 showing the top view of bed). Being fit within the respective concaves, the side members 12Rb and 12Lb obstruct neither the side members 12Ra and 12La nor the side members 12Rc and 12Lc in the thickness directions even when bed frame 10 is adjusted to the flexion position. In addition, the bar 22R is coupled to the side beam 21R by couplers 236Ra and 236Rb, and the bar 22L is coupled to the side beam 21L by couplers 236La and 236Lb. Owing to the coupling to the side beams 21R and 21L, the bars 22R and 22L are allowed to freely rotate on their axes while remaining secured to the side beams 21R and 21L. By rotating the side-member support frames 24R and 24L on the axes of the rotating bars 22R and 22L to a vertical position (in the z direction), the side members 12Ra-12Rd and 12La-12Ld are pushed upward to a risen position.

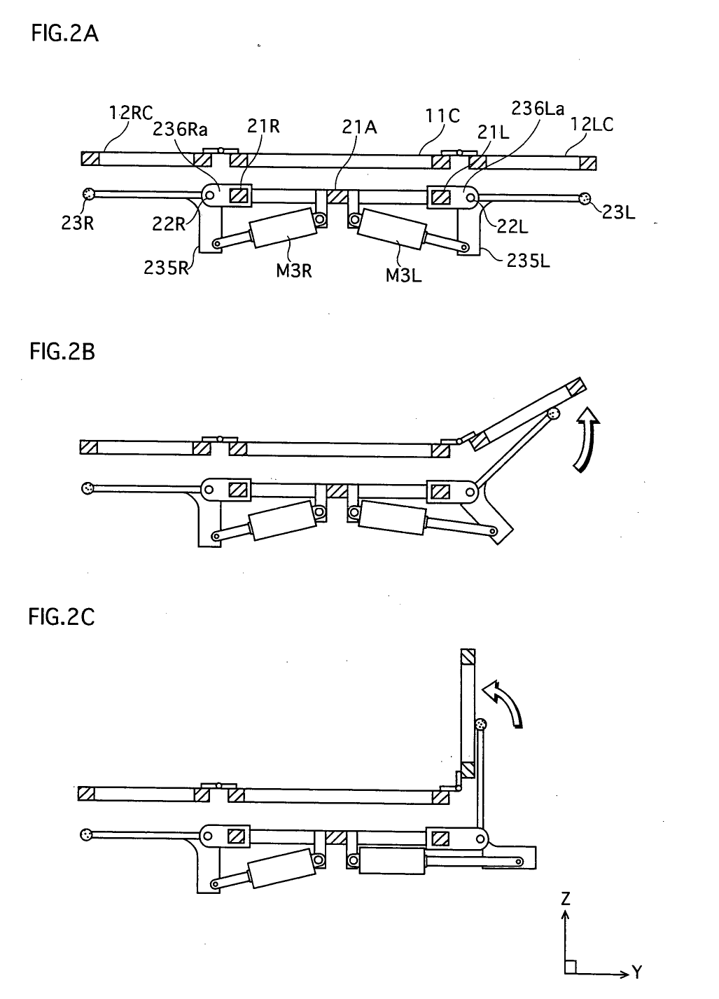

FIGS. 2A-2C are schematic sectional views of the adjustable stage 20 and the bed frame 10, taken laterally across the lower-back member 11c to illustrate the operations of the actuators. As shown in the figures, the adjustable stage 20 is provided with the above-described actuators M1 and M2 for changing the profile of the bed frame 10. In addition, the adjustable stage 20 is provided with direct-acting actuators M3R and M3L disposed in laterally symmetric relation to the center beam 21A. Specifically, the actuators M3R and M3L are disposed on the right and left of the y direction correspondingly to the couplers 236Ra and 236La. The end of each shaft of the actuators M3R and M3L is respectively coupled to the L-shaped members 235R and 235L, which are hung from the respective rotating bars 22R and 22L. With this structure, when the shaft of each of the actuators M3R and M3L extends, the L-shaped members 235R and 235L and the bars 23R and 23L rotate on the rotating bars 22R and 22L. As a result, the side-member support frames 24R and 24L rise from the horizontal surface of the bed to form a right angle with respect to the bed surface (FIGS. 2A→2B→2C).

On the underside of the side beams 21R and 21L, stage bars 27R and 27L are provided. On the fixed stage 30 are provided stage-bar receives 36R and 36L having a U-shaped cross section to receive the stage bars 27R and 27L, respectively. Reverse L-shape pawls are disposed inside each of the stage-bar bearings 36R and 36L along the width-wise direction. The pawls engage around the stage bars 27R and 27L received in the stage-bar bearings 36R and 36L, so that the adjustable stage 20 is fixed against the vertical movement. Yet, when the adjustable stage 20 is tilted, one of the stage bars 27R and 27L are lifted and detached from the respective one of the stage-bar bearings 36R and 36L.

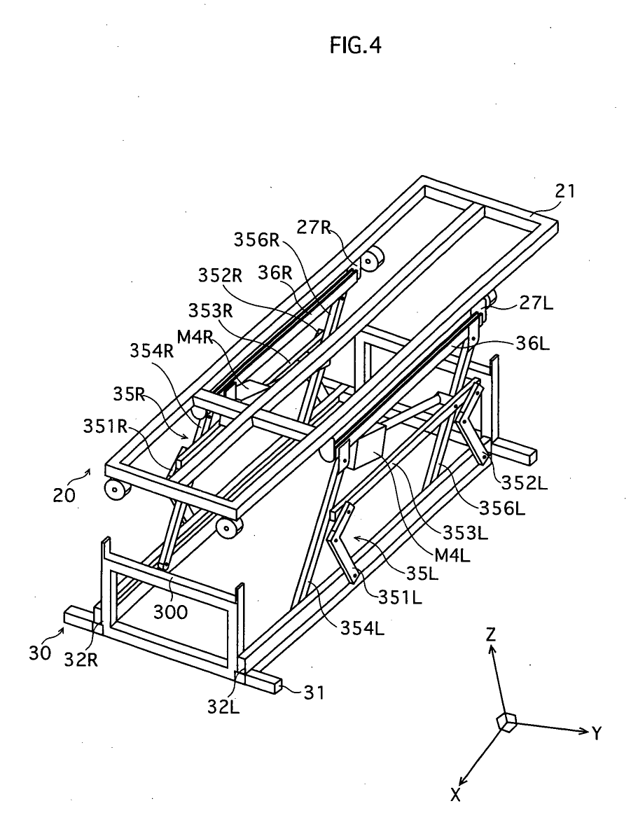

FIG. 4 is an oblique view of the fixed stage 30. The fixed stage 30 is provided with a rectangular frame 31. One of a pair of shorter opposite sides of the rectangular frame 31 constitutes the roller slide frame 300 along which the rollers 200-203 of the adjustable stage 20 slide back and forth. Side beams 32R and 32L of the fixed stage 30 constitute sliding channels substantially defining a laterally oriented U-shape in cross section with their openings facing each other. Support arms 354R and 356R are both coupled at one end to the stage-bar bearings 36R, and to the side beam 32R at the other end in a manner freely slidable along the side beam 32R. Similarly, support arms 354L and 356L are both coupled at one end to the stage-bar bearing 36L, and to the side beam 32L at the other end in a manner freely slidable along the side beam 32L. In addition, the support arms 354R, 356R, 354L, and 356L are separately linked to reverse L-shaped rotating arms 351R, 352R, 351L, and 352L. The rotating arms 351R, 352R, 351L, and 352L are coupled at one end to the side beams 32R and 32L, and also to horizontal links 353R and 353L the other end. An actuator M4R is disposed at an angle between the stage-bar bearing 36R and the horizontal link 353R. Similarly, an actuator M4L is disposed at an angle between the stage-bar bearing 36L and the horizontal link 353L. With the above arrangement, parallelogram mechanisms 35R and 35L are constituted one on each lateral side of the fixed stage 30. With parallelogram mechanisms 35R and 35L employing a horizontal sliding mechanism, the rotating arms 351R, 352R, 351L, and 352L make a circular motion about the linked points on the side beams 32R and 32L. In response to the circular motion of the rotating arms 351R, 352R, 351L, and 352L, the ends of the support arms 354R, 356R, 354L, and 356L move back and forth within the grooves of the side beams 32R and 32L. When the support arms 354R, 356R, 354L, and 356L swing toward a vertical position, the adjustable stage 20 as well as the bed frame 10 supported by the stage-bar bearings 36R and 36L vertically moves away from or toward the right and left sides of fixed stage 30. That is to say, the bed 1 is capable of up and down movement within a narrow space and is of a space-saving configuration. In addition, the rollers 200-203 and the parallelogram mechanisms 35R and 35L enable the postural change operations without requiring much space. By driving one of the parallelogram mechanisms 35R and 35L at a time for the movement of either of the side beams 32R and 32L, the bed 1 is adjusted its profile for the postural change from a supine posture to a lateral side-lying posture. On the other hand, driving both the parallelogram mechanisms 35R and 35L at the same time, the High/Low operation of the bed 1 is carried out.

The drive of the actuators M1, M2, M3R, and M3L are controlled by a motor driver 403 and a CPU 401 provided with in a control unit 400, all of which are described later. The drive setting including pre-programming may be made automatically or manually by the caregiver using a controller (not illustrated) at hand. Furthermore, with the use of a remote controller of an infrared, wired, or wireless type, the drive setting may be made by the care recipient.

Note that the structure of the adjustable bed 1 described above 1 is one example. As later described, the mechanics covers 370R and 370L, which are a feature of the present invention, may be applied to an adjustable bed having a different structure.

1-2. Operations of Adjustable Bed (Supine→Lateral)

The adjustable bed having the above structure is put to actual use with a mattress overlaid on the bed frame 10. The detailed description of the mattress is described later in detail. In the normal profile, the platform members 11a-11d and the side members 12Ra-12Rd and 12La-12Ld are all disposed substantially horizontal and together constitute a bed surface, as shown in FIG. 1.

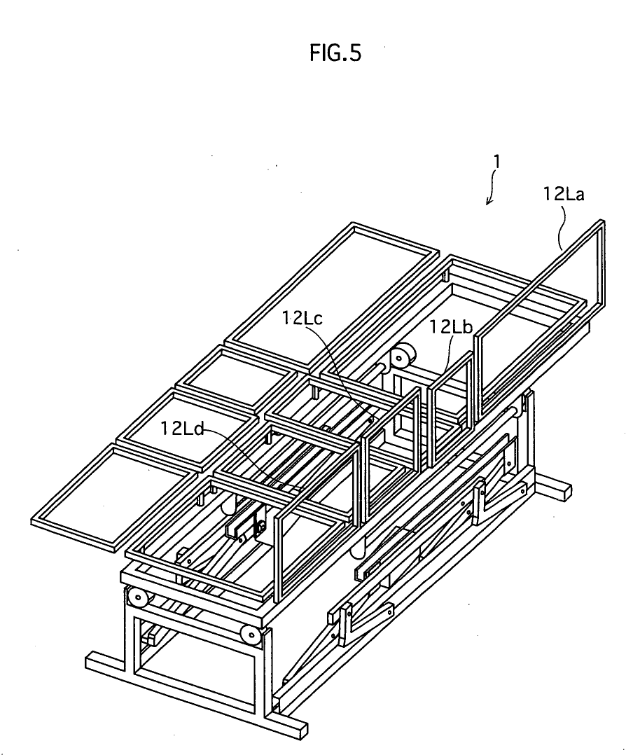

First, a user (caregiver, in this example) selects and executes on the controller a menu for a postural change from a supine and flexion posture to a left side-lying and flexion posture. In response, the actuator M3L attached to the adjustable stage 20 is activated and extends its shaft. Then, the bar 23L and the L-shaped member 235L coupled to the end of the shaft rotate about the rotating bar 22L. As a result, the side-member support frame 24L comes to rise and form a right angle with respect to the horizontal bed surface. (See FIGS. 2A→2B→2C illustrating the actuator operations; FIG. 5 showing the state of the side members 12La-12Ld in a raised state; and FIG. 8C showing the side view of the bed in the raised state).

Next, the direct-acting actuators M1 and M2 attached to the center beam 21A of the adjustable stage 20 extend their shafts, thereby separately pushing, via the L-shaped couplers 211 and 212, the upper-body member 11a and the lower-back member 11c of the bed frame 10 from the rear. As a result, the bed is adjusted to a position for the care recipient to be in a flexion posture with the upper body raised and the knees up (see FIG. 6 showing an oblique view of the bed in the flexion position; and FIGS. 8→8B showing side views of the bed in this state). With the positional change of the platform members 11a-11d, the side members 12La-12Ld also change their positions accordingly. As a result, the fan-shaped members 13L comes out from the pocket of the side member 12Lc to support parts of the mattress around the care recipient's knees (see FIGS. 8C→8D showing side views of the bed in this state).

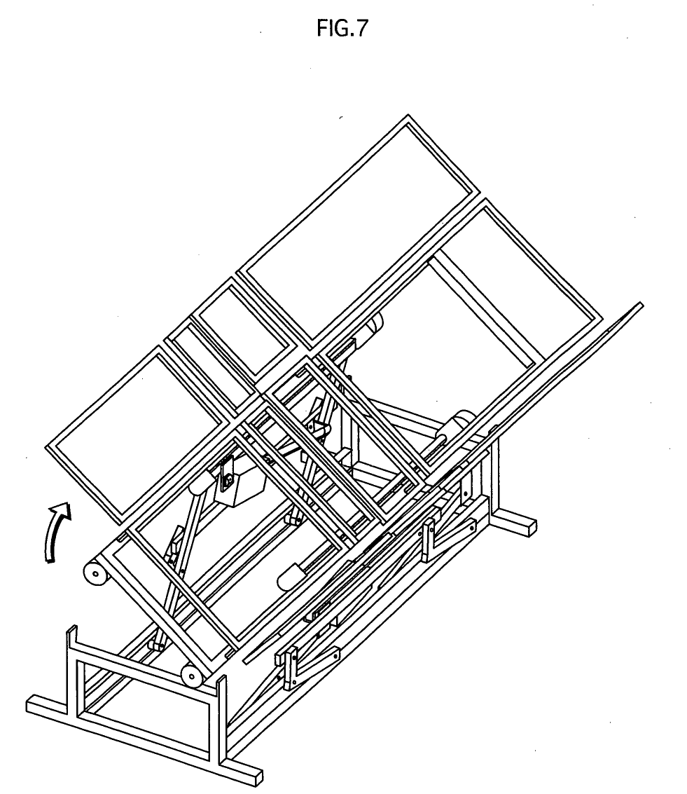

When the above operations bring the bed to the flexion position with the left side members risen up, the actuator M4R disposed on the side beam 32R of the fixed stage 30 then extends its shaft to widen the distance between the stage-bar bearing 36R and the horizontal link 353R. As a result, the support arms 354R and 356R slide in the sliding groove of the side beam 32R to a more upright position. Thus, the parallelogram mechanism 35R works. At this stage, the two support arms 354R and 356R or 354L and 356L come to vertically lift the right side of the adjustable stage 20 in response to the circular motion of the two rotating arms 351R and 352R or 351L and 352L. Thus, the right side of the adjustable stage 20 is vertically lifted to a level higher than the fixed stage 30, thereby causing the rollers 201-204 to run on the roller slide frame 300. Consequently, the bed frame 10 downwardly inclines toward the side beam 32L of the fixed stage 30, i.e. toward the left side of the bed (see FIG. 7 showing the bed in the inclined state). Preferably, the inclination angle of the bed to the horizontal surface falls within the range of about 30° to 70°, for example about 50°.

With the changes in the profile of the bed frame 10, the care recipient is assisted to smoothly change the posture from a supine to a lateral position while being supported by the platform members 11a-11d and the side members 12La-12Ld, after firstly being placed in a supine flexion position with the upper body raised and the knees flexed. The above postural change is smoothly carried out as if the care recipient' body rolls along the hands of caregiver put to support the care recipient.

Now, a description is given to a main feature of the present invention.

1-3. Safety Mechanism of Adjustable Bed

FIG. 9 is a view showing the adjustable bed provided with a safety mechanism. More specifically, the figure shows the structure around the fixed stage of the bed. In the example shown in the figure, the parallelogram mechanisms 35R and 35L are provided with the mechanics cover 370R and 370L, respectively. Each mechanics cover is shaped like a plate and covers the respective parallelogram mechanism from outside.

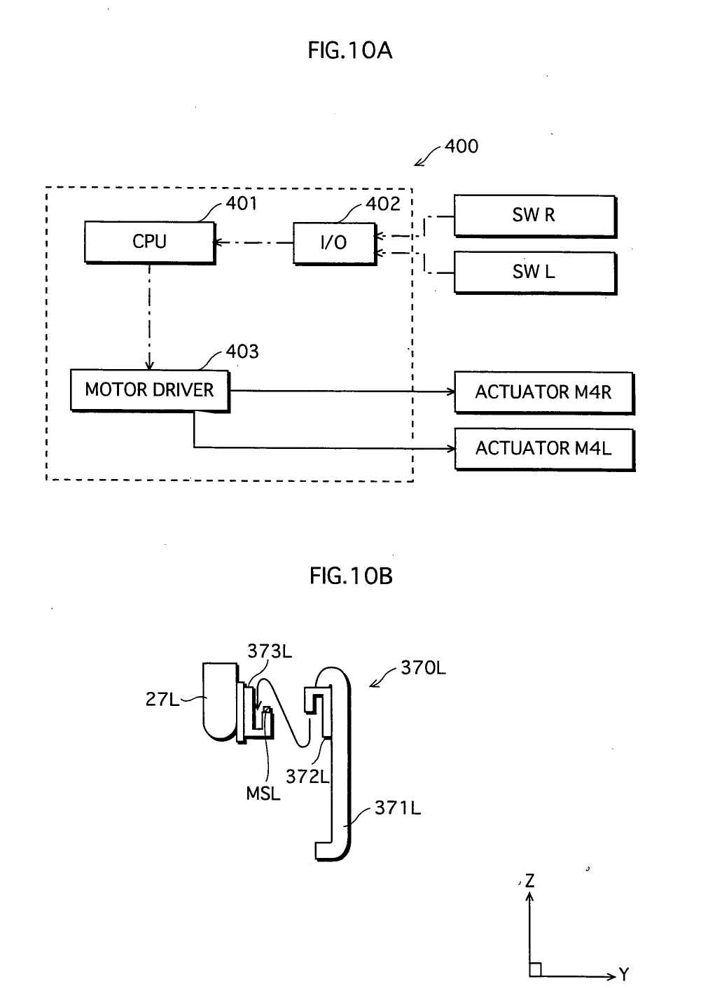

In one specific example, the main body of each of the mechanics covers 370R and 370L is made of a styrene board. The mechanics cover 370R is attached to the stage-bar bearing 36R by engagement between U-shaped metal pieces 372R and 373R (not illustrated). Similarly, the mechanics cover 370L is attached to the stage-bar bearing 36L by engagement between U-shaped metal pieces 372L and 373L. Thus, the mechanics covers 370R and 370L are hung upon the respective stage-bar bearings 36R and 36L along the lengthwise direction. Between each pair of engaging metal pieces 372R and 373R as well as 372L and 372R, a safety switch is provided. In this example, micro switches MSR and MSL (the micro switch MSL is not illustrated) are disposed between the respective pairs of metal pieces. As shown in FIG. 10A, the state of the micro switches MSR and MSL (SW R and SW L) is monitored by the CPU 401 via the I/O 402 of the control unit 400. Normally, the micro switches MSR and MSL are in ON state under the weight of the mechanics covers 370R and 370L. In the case where any foreign object (an arm of the caregiver, for example) lifts either of the mechanics covers 370R and 370L from underneath, a corresponding one of the metal piece pairs is disengaged. As a result, a corresponding one of the micro switches MSR and MSL is switched OFF, thereby stop issuing a detection signal. Upon detecting the absence of detection signal, the CPU 401 of the control unit 400 stops the drive of the actuators M4R and M4L in the parallelogram mechanisms 35R and 35L. As described above, the mechanics covers 370R and 370L function as elements triggering the ON/OFF state changeover of the micro switches MSR and MSL.

Although not illustrated in FIG. 10A, the actuators M1 and M2, which are driven to change the bed to a Gatch position, are also made to stop. Furthermore, although the micro switches MSR and MSL are employed in this example, other types of switches are applicable, including a push switch, a lever switch, and a slide switch.

With the above operations, the drive of the bed is immediately suspended in the case where the caregiver, care recipient, or family member accidentally places his hand in or around the parallelogram mechanisms while the bed is being driven. It is because when either of the mechanics covers 370R and 370L is lifted as a result of a contact with the hand, the pair of U-shaped metal pieces 372R and 373R or 372L and 373L is disengaged. With the above safety mechanism, the adjustable bed ensures significantly improved safety.

As above, the provision of the mechanics covers 370R and 370L offers a safety measurement to prevent that the caregiver, the care recipient, or a family member accidentally places a part of the body (a limb, for example) inside the bed to reach the moving parts, such as the parallelogram mechanisms 35R and 35L. In addition, the provision of the mechanics covers 370R and 370L serves to hide the moving parts, such as the parallelogram mechanisms 35R and 35L, from view.

Note that the present invention is not limited to the above configuration of suspending the drive of the bed upon disengagement of the pair of U-shaped metal pieces 372R and 373R or 372L and 373L. Alternatively, the present invention may be configured so as to switch off the drive of the parallelogram mechanisms 35R and 35L based on the detection signal from the micro switches, at the time when the pair of U-shaped metal pieces is lifted. It should be noted, in addition, that the present invention is not limited to the configuration employing the U-shaped metal pieces 372R, 373R, 372L, and 373L. Any configuration is applicable as long as the displacement of mechanics covers from the predetermined positions (where the mechanics covers are normally hung on) is detected, and the parallelogram mechanisms 35R and 35L are switched off in response to the detection signal.

Turning now to the size of the mechanics covers 370R and 370L, it is satisfactory that the mechanics covers 370R and 370L cover the parallelogram mechanisms 35R and 35L, as shown in FIG. 9. For further improving the safety, the mechanics covers 370R and 370L may be as large in lengthwise as the adjustable stage 20 in the direction X.

In addition, the above description is directed to the example in which the mechanics covers composed of styrene boards are disposed to cover the moving parts including the parallelogram mechanisms 35R and 35L from outside. Yet, when it is not so intensively requested to block the moving parts (i.e. when the mechanics covers 370R and 370L may used simply as means for triggering the micro switches MSR and MSL), the mechanics covers 370R and 370L may be composed of metallic or plastic frames (the overall size of the frames is preferably equal to the mechanics covers 370R and 370L as in the above example). Alternatively, a lattice or a plate made of a translucent resin may be applicable. The material and configuration of the mechanics covers 370R and 370L may be suitably altered.

In addition, the above example is directed to the case where the micro switches MSR and MSL are arranged between the pairs of the U-shaped metal pieces 372R and 372L as well as 373L and 373R that in turn arranged at the upper part of the parallelogram mechanisms 35R and 35L. Alternatively, however, the micro switches MSR and MSL may be arranged on any of the following elements 353R and 353L, 354R and 354L and 356R and 356L. In this case, instead of the mechanics covers 370R and 370L, the micro switches MSR and MSL may be each provided with a pole-like member or wire-like member as the triggering mechanism used in conjunction with, for example, the above-described U-shape metal pieces.

1-4. Supplemental Notes

The above embodiment 1 is directed to the bed structure employing the parallelogram mechanisms. Yet, the present invention is not limited to such a structure, and the adjustable bed may be of another structure as follows.

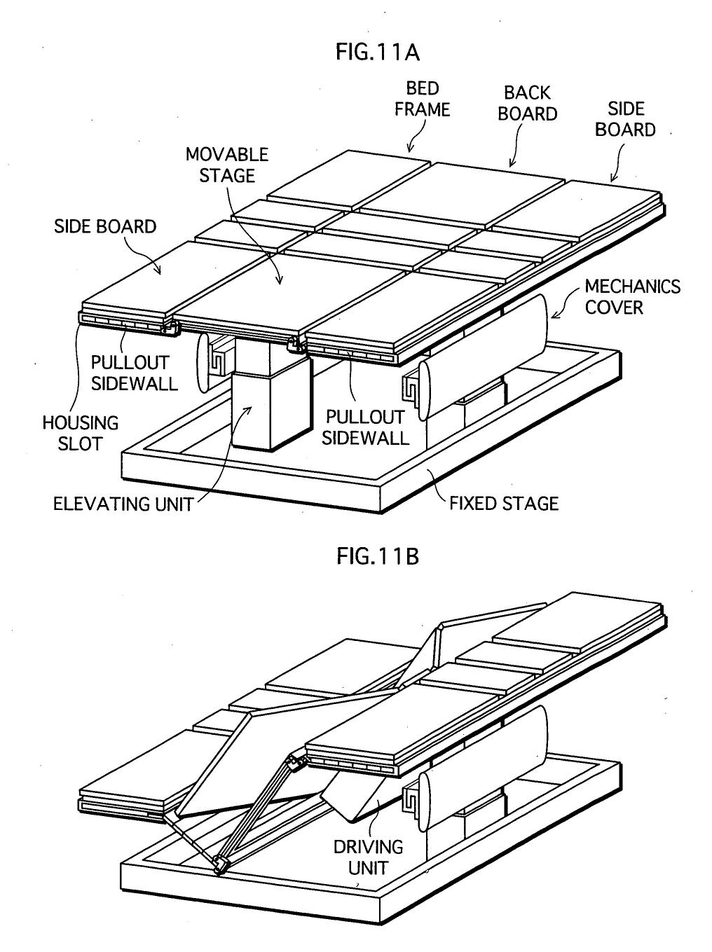

An adjustable bed shown in FIG. 11A is provided with vertically disposed direct-acting actuators. Using elevating mechanisms, either of left and right side members is moved up or down, thereby inclining a platform placed on an adjustable stage. The bed is provided with a rectangular frame serving as a fixed stage, and a pair of direct-acting actuators having columnar shape. On the top of the actuators is provided a bed frame supported by a flexible frame. Similarly to the embodiment 1, the platform of the bed is constituted by coupling a plurality of platform members, so as to receive the upper body, lower back, upper leg, and lower leg regions of the care recipient's body. Among the platform members, the one receiving the lower back of the care recipient's body is securely fixed to the platform frame serving as the movable frame. On the underside of the platform is provided a driving unit for driving an actuator mechanism used to change the bed to a flexion position.

The mechanics covers serving as a safety mechanism according to the present invention are disposed along a lateral side of each columnar actuator.

On the top of the columnar actuators, side members of the bed are disposed. The side members each have a housing slot formed therein, and a pullout wall is housed in each housing slot. The pullout walls are coupled to each other along a lengthwise direction of the bed. The side members are coupled to the adjustable stage via the respective pullout walls. Each pullout wall is biased toward inside the housing slot by a tension spring, for example. When the force puling out the pullout walls weakens, the pullout walls are automatically retracted back into the housing slots.

According to the modified adjustable bed, at the time of driving the bed, the coupled platform is first changed its profile to a flexion position, as shown in FIG. 11B. Then, one of the columnar actuators starts operating to descend either right or left side members. As a result, the adjustable stage, as well as the coupled platform, is laterally inclined. On the downwardly inclined lateral side of the adjustable stage, the pullout walls are pulled out from the housing slots to rise relatively to the coupled platform. In other words, the pullout walls are hung from the coupled platform so as to form a smaller angle therebetween. Correspondingly to the above profile change, the side members come to rise relative to the surface of the platform. With the above operations, the care recipient is suitably supported from the side by the pullout walls while in a flexion posture, thereby assisting the postural change as effectively as the embodiment 1. With this bed structure, the mechanics covers operate just as in the embodiment land provide a suitable safety mechanism.

In the above embodiment, the micro switches are normally ON, and turned OFF upon detection of a foreign object. Yet, the present invention is not limited to the above structure. The micro switches may be normally OFF, and turned ON upon detection of a foreign object. The ON/OFF state of the micro switches may be adapted to either way, depending on the circuitry configuration.

Furthermore, according to the above embodiment, it is the CPU 401 that controls the drive of the actuators. Yet, the drive control may be carried out without a CPU through the hardware structure (for example, a structure that interrupts the power supply to the driving systems such as the actuators when any of the micro switches are tuned OFF)

### INDUSTRIAL APPLICABILITY

The adjustable bed according to the present invention is suitably used as a nursing care bed or a reclining bed.

1. An adjustable bed, comprising:
a moving mechanism operable to at least tilt or move up and down a platform of the bed; and
a safety switch operable to turn on and off an operation of the moving mechanism, wherein
the safety switch is normally under pressure, and
upon release of the pressure, a power ON-OFF state of the safety switch is changed to suspend the operation of the moving mechanism.

2. The adjustable bed according to claim 1, further comprising
a changeover member operable, in response to movement of the platform, to change the power ON-OFF state of the safety switch.

3. The adjustable bed according to claim 1, further comprising
a cover disposed so as to cover an outer surface of the moving mechanism, wherein
the safety switch is disposed at a position determined relative to a position of the cover, and
the power ON-OFF state of the safety switch is changed upon displacement of the cover from the position.

4. The adjustable bed according to claim 3, wherein
the moving mechanism includes:
a flexing mechanism operable to flex the platform to form a flexion position that includes at least one of an upper body elevation and a knee flexion; and
a tilting mechanism operable to laterally tilt the platform,
the flexing and tilting mechanisms are each operable when the other mechanism is operating, and
the cover is mounted to the tilting mechanism.

5. The adjustable bed according to claim 1, further comprising:
a side member disposed on a side of the platform, and
a side member raising mechanism for raising the side member relative to the platform, wherein
the tilting mechanism downwardly tilts the platform toward the side member raised by the side member raising mechanism.
